(19) United States
(12) Patent Application Publication
(10) Pub. No.: US 2003/0162543 A1
(43) Pub. Date: Aug. 28, 2003

(54) System and method for interrupt-free hand-over in a mobile terminal

(75) Inventors: Tommi Auranen, Kaivokaru (FI); Kimmo Laiho, Ojarinne (FI); Harri Pekonen, Upalingontie (FI); Juha Kajava, Korvenperantie (FI)

Correspondence Address: BANNER & WITCOFF, 1001 G STREET N W, SUITE 1100, WASHINGTON, DC, 20001, US

(73) Assignee: Nokia Corporation

(21) Appl. No.: 10/085,910

(22) Filed: Feb. 28, 2002

(51) Int. Cl. H04Q 7/20

(52) U.S. Cl. 455/436; 455/432

(57) ABSTRACT

A system and method are disclosed for providing interrupt-free hand-over in a mobile terminal. First and second service signals broadcast by corresponding wireless transmitters are received and signal data is derived from the service signals. If the signal data from the first wireless transmitter meets a first predefined criterion and if the signal data from the second wireless transmitter meets a second predefined criterion, reception is switched from the first wireless transmitter to the second wireless transmitter after a predefined portion of the service signal has been received.

### CROSS REFERENCE TO RELATED APPLICATIONS

This application is related to commonly-assigned patent applications identified by Banner & Witcoff attorney docket numbers 004770.00033, 004770.00040, and 004770.00041.

### FIELD OF THE INVENTION

This invention relates to burst transmission of audio data, video data, control data, or other information and, in particular, to a system and method for providing interrupt-free hand-over in a mobile terminal.

### BACKGROUND OF THE INVENTION

Video streaming, data streaming, and broadband digital broadcast programming are increasing in popularity in wireless network applications. However, as mobile terminal receivers move among wireless transmission cells, information signals can be lost or corrupted, especially when a hand-over occurs. The present state of the art teaches use of dual receivers in mobile terminals to mitigate such problems, but such solutions add to the cost and complexity of mobile terminals.

What is needed is a system and method for providing an interrupt-free information and data flow to a mobile terminal receiving data and information from multiple wireless cells.

### SUMMARY OF THE INVENTION

The present invention provides a system and method for providing interrupt-free hand-over in a mobile terminal. First and second service signals broadcast by corresponding wireless transmitters are received and signal data is derived from the first and second service signals. If the signal data from the first wireless transmitter meets a first predefined criterion and if the signal data from the second wireless transmitter meets a second predefined criterion, reception is switched from the first wireless transmitter to the second wireless transmitter after a predefined portion of the service signal has been received.

### BRIEF DESCRIPTION OF THE DRAWINGS

The invention will be described in detail in the following description of preferred embodiments with reference to the following figures wherein:

FIG. 1 shows a simplified diagram of a conventional wireless communication system;

FIG. 2 shows a waveform of the signal broadcast by the conventional wireless communication system of FIG. 1;

FIG. 3 shows a first preferred embodiment of a time-slicing digital broadcasting system including a wireless mobile terminal and a plurality of transmitters broadcasting burst signal streams corresponding to information originating at a service provider;

FIG. 4 is a graph showing a generic waveform representing one of the burst signal streams of FIG. 3;

FIGS. 5A and 5B are a flow diagram illustrating operation of the mobile terminal of FIG. 3;

FIG. 6 is a diagram illustrating signal flow as broadcast from a digital broadcast transmitter to a digital broadcast receiver in the system of FIG. 3;

FIG. 7 is a functional block diagram of the digital broadcast receiver of FIG. 6; and

FIG. 8 is a diagram showing information signals broadcast from a plurality of service providers.

### DETAILED DESCRIPTION OF THE INVENTION

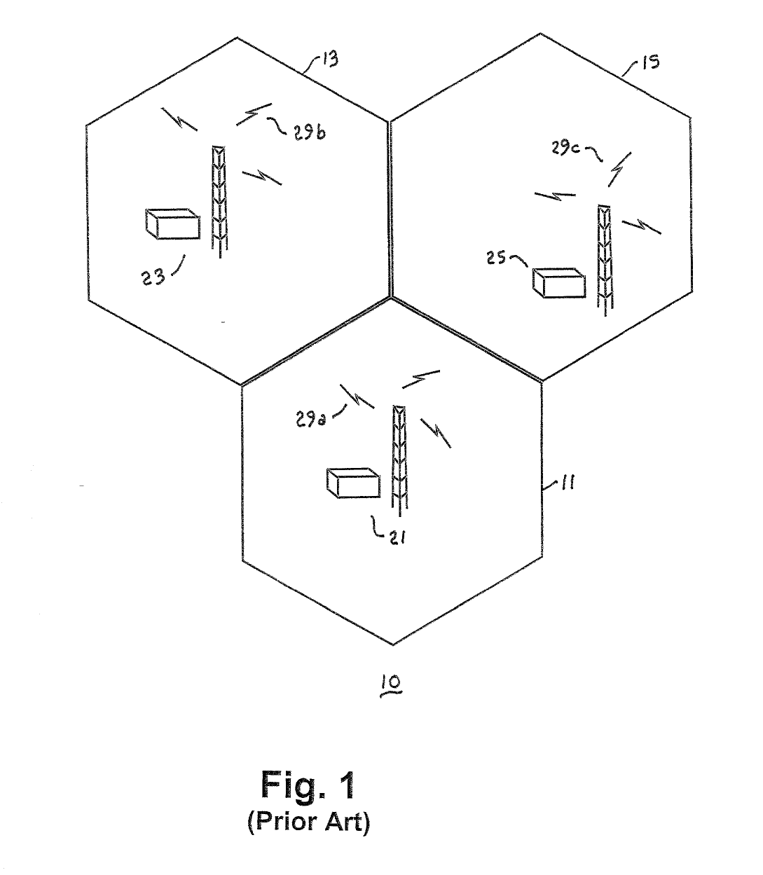

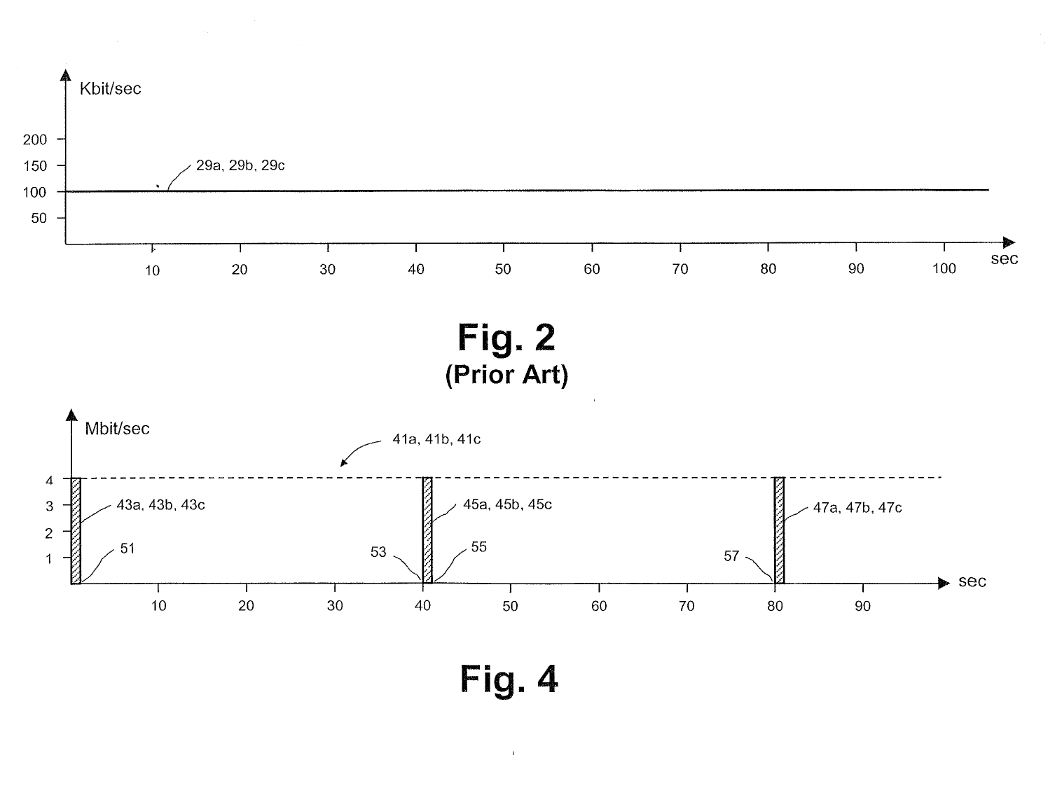

FIG. 1 is a simplified diagram of a conventional wireless system 10 operating via a plurality of wireless cells, exemplified by wireless cells 11, 13, and 15. The wireless cells 11, 13, and 15 each typically include a respective conventional transmitter 21, 23, and 25 broadcasting conventional information signals 29a, 29b, and 29c where each information signal 29a-29c may be transmitted on a different frequency. As shown in FIG. 2, each conventional information signal 29a-29c can be a continuous or a slowly-varying data stream which can have a bit rate of, for example, 100 Kbit/sec.

A mobile terminal such as a wireless receiver (not shown) located in the cell 11, for example, will most likely elect to receive the continuous information signal 29a as provided by the transmitter 21, in FIG. 1. Consequently, when the wireless receiver moves from the wireless cell 11 into either the wireless cell 13 or the wireless cell 15, there usually occurs a corresponding hand-over to receive either the information signal 29b from the transmitter 23 or the information signal 29c from the transmitter 25, for example, by changing the receiving frequency at the receiver. However, the action in switching from one continuous signal to another may result in an undesirable interruption in the information signal acquired by the wireless receiver.

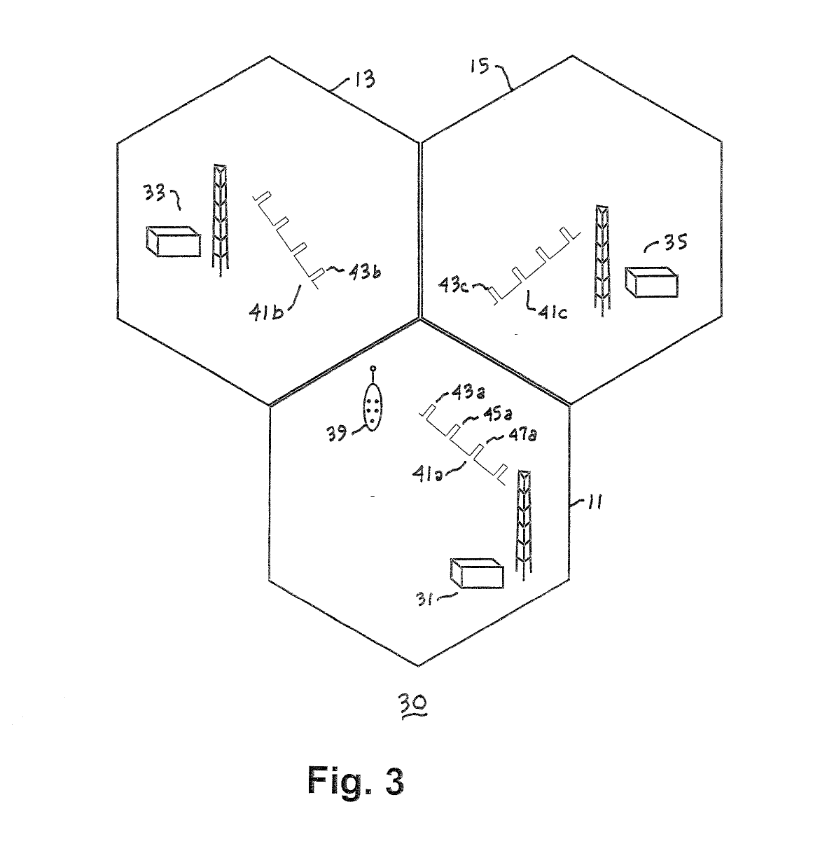

There is shown in FIG. 3 a simplified diagram of a time-slicing digital broadcasting system 30 incorporating the features of the present invention. The broadcasting system 30 is shown operating in a transmission region that includes the wireless cells 11, 13, and 15. A first transmitter 31 is located in the wireless cell 11, a second transmitter 33 is located in the wireless cell 13, and a third transmitter 35 is located in the wireless cell 15. The transmitters 31-33 broadcast corresponding service signals 41a-41c all of which are received by a mobile terminal 39. The service signals 41a-41c comprise information or data produced by a common service provider (not shown) and converted into transmission signals by the respective transmitters 31-33. Each of the service signals 41a-41c is transmitted on a different frequency to enable the mobile terminal 39 to discriminate between the service signals 41a-41c. Alternatively, signal discrimination can be achieved by transmitting the service signals 41a-41c using different coding schemes or other radio frequency transmission formats.

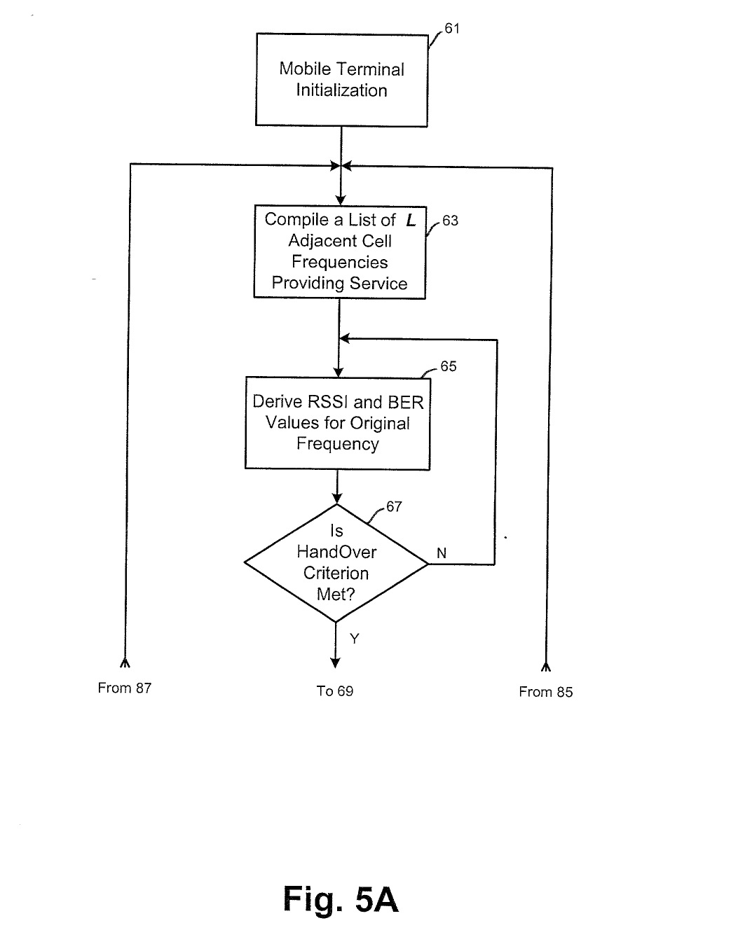

The waveforms of the service signals 41a-41c are shown in greater detail in FIG. 4. The service signal 41a, for example, comprises a series of transmission bursts, exemplified by a transmission burst 43a, a transmission burst 45a, and a transmission burst 47a. Similarly, the service signal 41b broadcast by the second transmitter 33 includes transmission bursts 43b, 45b, and 47b, and the service signal 41c broadcast by the third transmitter 35 includes transmission bursts 43c, 45c, and 47c. As indicated by the graph, the service signals 41a-41c are preferably synchronized such that the transmission bursts 43a, 43b, and 43c are broadcast by the respective burst transmitters 31-33 at the same time. Similarly, the transmission bursts 45a, 45b, and 45c are synchronized, and the transmission bursts 47a, 47b, and 47c are synchronized.

In a preferred embodiment, each of the transmission bursts 43a-43c, 45a-45c, and 47a-47c is a 4-Mbit/sec pulse approximately one second in duration to provide a transfer of four Mbits of buffered information per transmission burst. The transmission bursts 43a-43c, 45a-45c, and 47a-47c are spaced at approximately 40-second intervals such that each of the waveforms 41a-41c effectively produce an average signal information transmittal rate of 100 Kbits per second. The waveforms 41a-41c thus achieve the same effective transmittal rate as, for example, the continuous 100 Kbit/sec transmittal rate of the information signals 29a-29c received from the service provider, above. But, in contrast to the information signals 29a-29c, the waveforms 41a-41c also provide intervening 39-second time intervals when there is no information signal transmittal occurring.

When a hand-over is required in the broadcasting system 30, the hand-over is performed only during one of these approximately 39-second time intervals which occur between transmission bursts of a selected service provider. The 39-second time interval allows the mobile terminal 39 to initiate and complete the switch from one transmitter signal to another without causing an interrupt in the received signal. For example, the mobile terminal 39 can elect to receive the transmission burst 43a, can then switch to receive one of the transmission bursts 45b or 45c, and can then switch again to receive any one of the transmission bursts 47a or 47b or 47c by selectively passing the frequency of whichever of the transmitters 31-35 is providing the best signal at any particular time. The disclosed system and method thus provide for an interrupt-free hand-over to be initiated and completed during a time interval in which no data transmission is expected from a selected service provider.

When located in the wireless cell 11, the mobile terminal 39 will typically receive the service signal 41a from the first transmitter 31 as the best signal. However, as the mobile terminal 39 moves from the wireless cell 11 into the wireless cell 13, the received signal strength of the service signal 41a may drop to a value less than the received signal strength of the service signal 41b. Accordingly, when such a signal attenuation occurs or another predefined service signal criterion is met, as described in greater detail below, the mobile terminal 39 may change from receiving the frequency of the first transmitter 31 broadcasting the service signal 41a to receiving the frequency used by the second transmitter 33 broadcasting service signal 41b.

If the predefined service signal criterion is met after the mobile terminal 39 has input the signal provided by the transmission burst 43a, for example, the change in frequency will preferably occur in the time interval between a termination point 51 of the transmission burst 43a (here shown at t=1 sec) and an initiation point 53 of the next transmission burst 45b (here shown at t=40 sec). In this way, the mobile terminal 39 receives each of the transmission bursts 43a and 45b in their entirety and thus incurs no interrupts during hand-over, if any, from one burst terminal to another. Alternatively, if the mobile terminal 39 had already input the transmission burst 45a, and the predefined criterion has been met, the change in frequency would instead occur between a termination point 55 of the transmission burst 45a and an initiation point 57 of the next transmission burst 47b (here shown at t=80 sec).

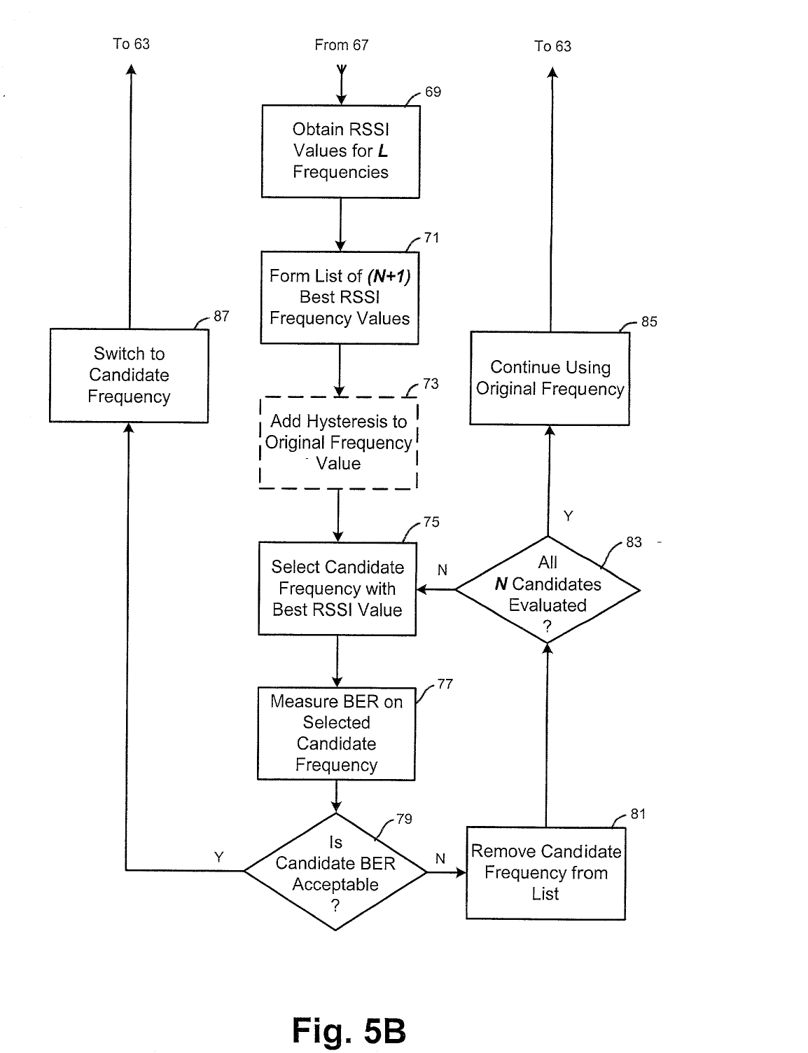

This process is illustrated in greater detail in the flow diagram of FIG. 5. After initialization of the mobile terminal 39, at step 61, the mobile terminal 39 compiles a list of ‘L’ alternative frequencies for one or more wireless cells adjacent to the wireless cell 11 which are providing the desired service, at step 63. In the example provided, this list would include the broadcasting frequencies for wireless cells 13 and 15 as the transmitters 33 and 35 are located in the adjacent cells 13 and 15 and are broadcasting service signals 41b and 41c. The alternative frequencies are provided in the service signals 41a, 41b, and 41c broadcast by the transmitters 31, 33, and 35. For example, the service signal 41a transmitted by the transmitter 31 will include a list of frequencies providing the same service broadcast in the service signal 41a. This would include the frequencies of the signals broadcast by the transmitters 33 and 35.

Signal data are derived in the mobile terminal 39, at step 65. These data include a received signal strength indicator (RSSI) value and a bit-error rate (BER) value for the signal frequency, here designated as the original frequency, used by the transmitter 31 in the wireless cell 11. A hand-over is considered or initiated if a predetermined hand-over criterion has been met. In a preferred embodiment, the hand-over criterion is met if the original frequency BER exceeds a predetermined quasi-error-free (QEF) limit or, alternatively, if the original frequency RSSI falls below a predefined value.

If the hand-over criterion is not met, at decision block 67, the mobile terminal 39 continues to monitor the original frequency RSSI and BER values for adverse change. On the other hand, if the hand-over criterion has been met, the mobile terminal measures or determines the RSSI values for the ‘L’ adjacent cell transmission signal frequencies providing the same service, at step 69. The ‘L’ RSSI values for the adjacent cell transmission signal frequencies can be readings obtained after the hand-over criterion is met, or the RSSI values can be values which have been obtained and averaged over a selected period of time and retained in the mobile terminal 39. Selection of a candidate signal frequency for hand-over is a function of the RSSI values obtained for the ‘L’ adjacent cell transmission signal frequencies.

The ‘N’ adjacent cell frequencies having the strongest RSSI values are designated as ‘N’ candidate frequencies, where N≦L. In a preferred embodiment, 3≦N≦5. A list of (N+1) RSSI frequency values is formed including the ‘N’ candidate frequencies and the original frequency, at step 71. In an alternative embodiment, the RSSI value for the original frequency is increased by a predetermined hysteresis value, for example 5 dB, to decrease the likelihood of frequent or unnecessary hand-overs from the original frequency to a candidate frequency, at optional step 73. The candidate frequency having the greatest RSSI value is selected from the list, at step 75, and the BER value is measured for this current candidate frequency, at step 77.

If the current candidate frequency BER value exceeds the predetermined QEF limit, at decision block 79, the current candidate frequency is removed from the list, at step 81 and, if additional candidate frequencies remain in the list, at decision block 83, the next candidate frequency value having the greatest RSSI value is designated as the current candidate frequency, at step 75, and the process proceeds to step 77 as above. If no candidate frequency values remain in the list, at decision block 83, the mobile terminal 39 continues to use the original frequency in receiving information, at step 85, and operation continues to step 63.

If the current candidate frequency BER value does not exceed the predetermined QEF limit, at decision block 79, the mobile terminal 39 executes a hand-over by switching to the current candidate frequency for receiving the next transmission burst, at step 87, and operation returns to step 63 as above. In a preferred embodiment, the QEF limit corresponds to a BER value of approximately 2×10⁻⁴ after Viterbi decoding in a digital video broadcasting receiver. As can be appreciated by one skilled in the relevant art, an error-correction chain utilized in the digital video broadcasting receiver may include a Viterbi decoder stage and a Reed Solomon decoder stage. Accordingly, the BER value of approximately 2×10⁻⁴ after Viterbi decoding corresponds to a BER value of approximately 10⁻¹² after Reed Solomon decoding.

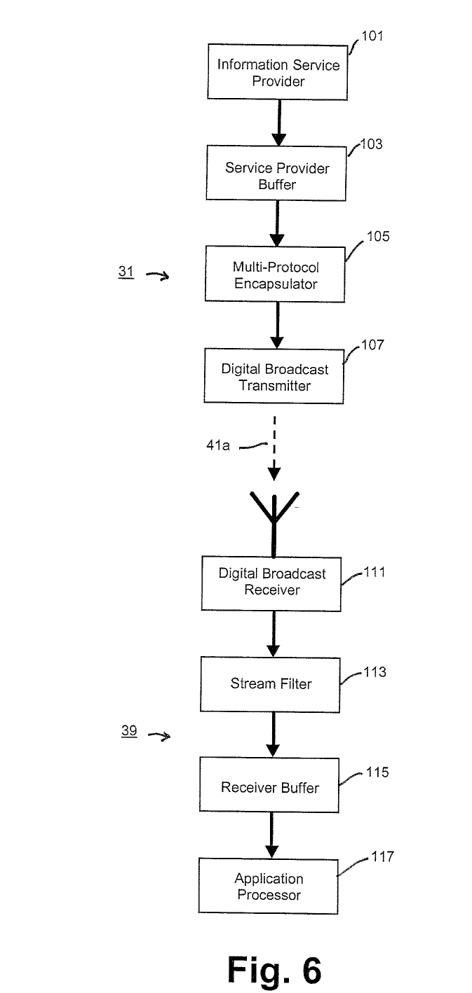

There is shown in FIG. 6 a preferred embodiment of a transmitter 31 broadcasting, for example the service signal 41a, to the mobile terminal 39. In a preferred embodiment, the mobile terminal 39 includes a digital broadcast receiver 111. The transmitter 31 receives an information stream, such as a streaming video signal, from an information service provider 101 via a network connection such as the Internet. The information stream is stored in an elastic buffer 103 and formatted into a series of transmission bursts, as is known in the relevant art.

Each transmission burst is then formatted by using, for example, a multi-protocol encapsulator 105 in accordance with Section 7 of European Standard EN 301192 “Digital Video Broadcasting (DVB); DVB specification for data broadcasting.” The encapsulation may conform to Internet Protocol (IP) standards, for example. After encapsulation, each transmission burst is provided by the multi-protocol encapsulator 105 to a digital broadcast transmitter 107. The digital broadcast transmitter 107 periodically sends the series of transmission bursts from the multi-protocol encapsulator 105 to a digital broadcast receiver 111 as the service signal 41a.

The digital broadcast receiver 111 provides the incoming series of transmission bursts comprising the service signal 41a to a stream filtering unit 113 to strip the encapsulation from the individual transmission bursts. The filtered output of the stream filtering unit 113 is then sent to a receiver elastic buffer 115 which functions to temporarily store filtered, stripped transmission bursts before being sent downstream to an application processor 117 for conversion into a substantially continuous information data stream or series of data packets.

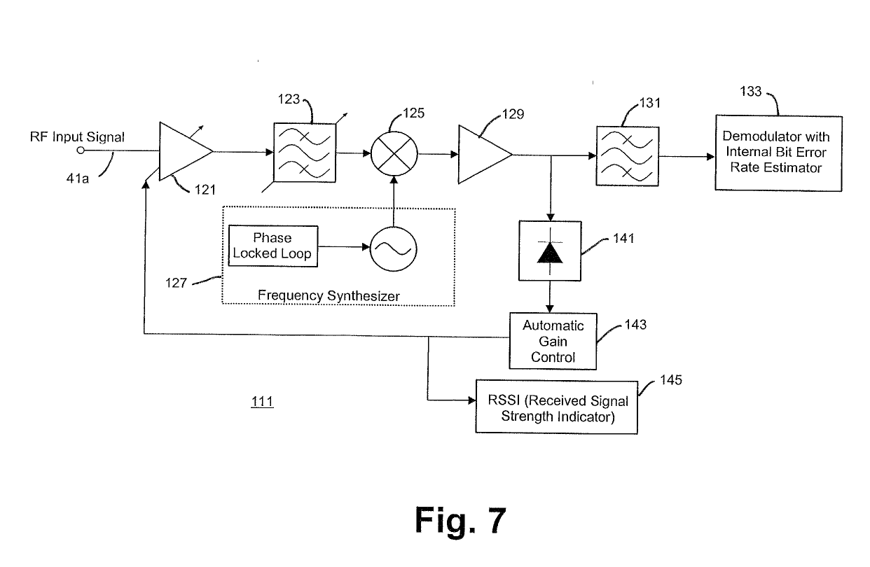

A preferred embodiment of the digital broadcast receiver 111 is shown in greater detail in FIG. 7. An RF input signal, such as the service signal 41a, is input to a variable-gain RF amplifier 121 and selected for reception via a variable tracking filter 123. The tracking filter 123 also provides the method by which frequency switching is accomplished during a hand-over operation. The signal provided by the tracking filter 123 is downconverted into an IF signal by a mixer 125 having an input from a frequency synthesizer 127 provided to one input port, as is well-known in the relevant art. The output of the mixer 125 is amplified by an IF amplifier 129 and filtered via a bandpass filter 131 before being sent to a digital demodulator 133. The demodulator 133 includes a bit-error-rate estimator for deriving a BER value for the incoming RF input signal, such as the service signal 41a.

The output of the IF amplifier 129 is also provided to a power detector 141 which provides a reference signal to an automatic gain control 143. The gain of the variable-gain RF amplifier 121, which is initially set to an intermediate level, is controlled using feedback from the automatic gain control 143. The automatic gain control 143 functions to compare the IF power detected via the power detector 141 with a target IF power level. If the detected IF power level is too low, the automatic gain control 143 increases the gain of the variable-gain RF amplifier 121. Conversely, the gain is decreased if the detected IF power level is too low.

The control voltage provided to the variable-gain RF amplifier 121 by the automatic gain control 143 is thus directly proportional to the level of the RF input signal (e.g., the service signal 41a). If a low-level RF input signal is received, the variable-gain RF amplifier 121 requires more gain to provide the target IF power level. The resultant feedback loop can thus be used to provide an indication of RF input signal strength via a received signal strength indicator 145.

Bit error rate estimation is performed in the digital demodulator 133. The digital demodulator 133 uses an error correction block to estimate the initial bit error rate prior to error correction. In the preferred embodiment, the BER is considered to be 100% correct if error correction is able to correct all errors. As can be appreciated by one skilled in the relevant art, the bit error rate value is directly proportional to the quality of the service signal 41a and, therefore, to the signal level.

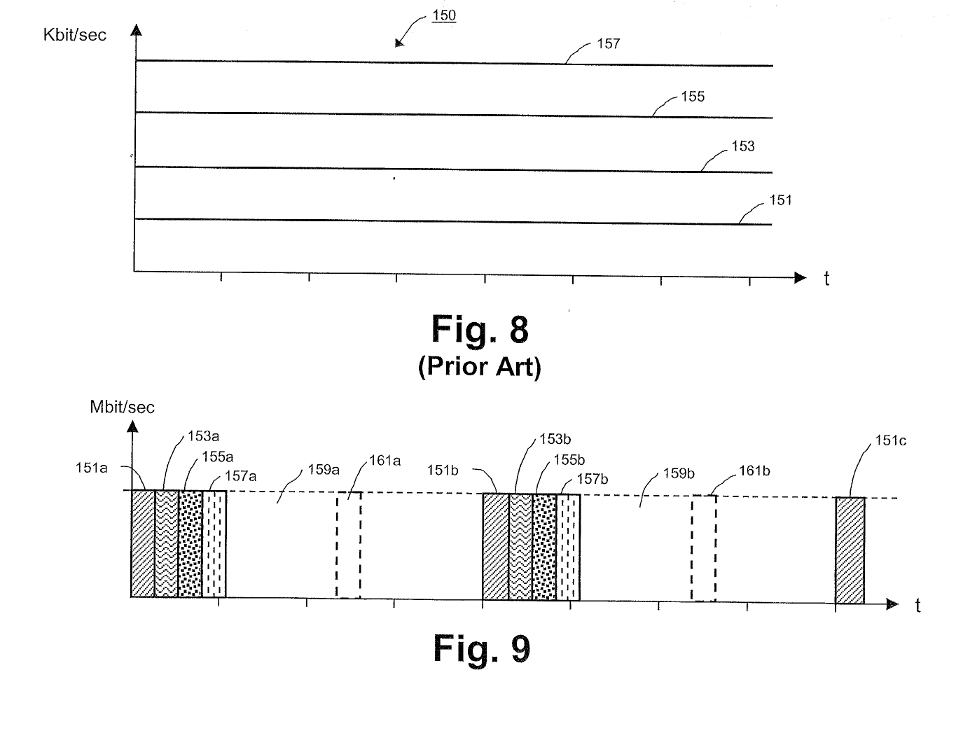

It should be understood that the mobile terminal 39 may also receive a signal stream 150 comprising service signals comprising information or data provided by one or more other service providers, as shown in the diagram of FIG. 8. For example, the signal stream 150 may include a first transmission burst 151a provided by a first service provider, a first transmission burst 153a provided by a second service provider, a first transmission burst 155a provided by a third service provider, a first transmission burst 157a provided by a fourth service provider, and a first transmission burst 159a provided by a fifth service provider. In the example provided, the first series of transmission bursts 151a-159a is followed by a first null packet transmission interval 160a.

The first null packet transmission interval 160a is followed by a second series of transmission bursts 151b-159b provided by the first through fifth service providers respectively. A second null packet transmission interval 160b follows the second series of transmission bursts 151b-159b. If desired, hand-over operations can be performed in the first or second null packet transmission intervals 160a and 160b. In addition, if the mobile terminal 39 is receiving only the information signals provided by the first service provider, hand-over can be performed during the broadcast of the transmission burst 153a-159a and 153b-159b as well.

As can be appreciated by one skilled in the relevant art, the time-slicing digital broadcasting system 30 may use modulation/demodulation methods such as Frequency Division Multiple Access (FDMA), Time Division Multiple Access (TDMA), Code Division Multiple Access (CDMA), or Wideband CDMA (WCDMA) coding to assign different transmission channels to the different service providers. Such channels enable the mobile terminal 39 to distinguish between information and data provided by the various service providers and to enable the mobile terminal 39 to select one or more of such services for reception.

While the invention has been described with reference to particular embodiments, it will be understood that the present invention is by no means limited to the particular constructions and methods herein disclosed and/or shown in the drawings, but also comprises any modifications or equivalents within the scope of the claims.

We claim:

1. A method for receiving at a mobile terminal a service signal formatted as a series of transmission bursts, the service signal provided by each of a plurality of wireless transmitters, said method comprising the steps of:
receiving a first service signal broadcast by a first wireless transmitter at a first frequency;
if said first service signal meets a first predefined criterion, deriving signal data from a second service signal broadcast by a second wireless transmitter; and
if said signal data from said second wireless transmitter meets a second predefined criterion, switching reception from said first wireless transmitter to said second wireless transmitter after a first service signal transmission burst has been received.

2. A method as in claim 1 wherein said first service signal broadcast by said first wireless transmitter is synchronized with said second service signal broadcast by said second wireless transmitter.

3. A method as in claim 1 further comprising the step of stripping encapsulation from said first service signal after receipt by the mobile terminal.

4. A method as in claim 3 wherein said encapsulation conforms to standard EN 301192.

5. A method as in claim 3 further comprising the step of sending said first service signal to an application processor for conversion to a data packet.

6. A method as in claim 1 wherein said first criterion is met if a receiver signal strength value for said first service signal measured by the mobile terminal is less than a predetermined value.

7. A method as in claim 1 wherein said first criterion is met if a bit error rate for said first service signal measured by the mobile terminal is greater than a predetermined value.

8. A method as in claim 1 wherein said second criterion is met if a bit error rate for said second service signal measured by the mobile terminal is smaller than a predetermined value.

9. A mobile terminal suitable for receiving information from a plurality of wireless transmitters, said mobile terminal comprising:
a digital broadcast receiver for receiving at least a first portion of the information as a first transmission burst, said first transmission burst broadcast by a first wireless transmitter;
a receiver elastic buffer for storing said first transmission burst; and
means for switching reception from the first wireless transmitter to a second wireless transmitter after reception of said first transmission burst has been completed.

10. The mobile terminal as in claim 9 further comprising means for deriving a bit error rate for said first transmission burst.

11. The mobile terminal as in claim 9 further comprising means for deriving a received signal strength indicator value for said first transmission burst.

12. The mobile terminal as in claim 9 wherein said means for switching is operative in response to said second wireless transmitter providing to said mobile terminal a signal meeting a predefined criterion.

13. The mobile terminal as in claim 9 further comprising an application processor for converting said first transmission burst into an information data stream.

14. The mobile terminal as in claim 9 further comprising a stream filter for stripping transmission encapsulation from said transmission burst stored in said receiver elastic buffer.

15. The mobile terminal as in claim 9 wherein said stream filter comprises an Internet protocol (IP) filter.

16. A digital broadcasting system comprising:
a first transmitter for broadcasting at least an interval of information as a transmission burst in synchronization with at least one other transmitter; and
a receiver system for receiving said transmission burst, said receiver including a receiver elastic buffer for buffering said transmission burst, said receiver further including means for executing a hand-over from said first transmitter to said at least one other transmitter upon receipt of said transmission burst if at least one predefined criterion has been met.

17. The digital broadcasting system as in claim 16 wherein said first transmitter comprises a multi-protocol encapsulator for encapsulating said transmission burst.

18. The digital broadcasting system as in claim 16 wherein said at least one predefined criterion is met if a receiver signal strength value for said transmission burst as measured by said receiver system is less than a predetermined value.

19. The digital broadcasting system as in claim 16 wherein said at least one predefined criterion is met if a bit error rate for said transmission burst as measured by the mobile terminal is greater than a predetermined value.

20. The digital broadcasting system as in claim 16 wherein said at least one predefined criterion is met if a bit error rate for a signal received from said at least one other transmitter as measured by the mobile terminal is smaller than a predetermined value.

21. A method for receiving a series of service signals provided by each of a plurality of wireless transmitters, said method comprising the steps of:
receiving service signals broadcast by a plurality of wireless transmitters, each said wireless transmitter broadcasting on a different frequency;
selecting a first wireless transmitter for providing information;
deriving a first bit error rate for information received from said first wireless transmitter;
if said first bit error rate for said first wireless transmitter is greater than a predefined quasi-error-free value, deriving a second bit-error-rate for a second wireless transmitter; and
if said second bit-error rate is less than said quasi-error-free value, selecting said second wireless transmitter for providing reception.

22. The method as in claim 21 wherein said step of selecting said second wireless transmitter for providing reception is performed after completing receipt of a service signal transmission burst from said first wireless transmitter.

23. The method as in claim 21 wherein said second wireless transmitter is selected from a plurality of transmitters as a function of received signal strength indicator value.
